(19) United States
(12) Patent Application Publication
(10) Pub. No.: US 2021/0182383 A1
(43) Pub. Date: Jun. 17, 2021

(54) TRIPLICATION REGISTER COMPRISING A SECURITY DEVICE

(71) Applicant: THALES, Courbevoie (FR)

(72) Inventors: Patrick DERVIN, MERIGNAC (FR); Frédéric CAUDOUX, MERIGNAC (FR); Jean MURZEAU, MERIGNAC (FR)

(21) Appl. No.: 17/110,238

(22) Filed: Dec. 2, 2020

(30) Foreign Application Priority Data
Dec. 17, 2019 (FR) 1914564

(51) Int. Cl. G06F 21/54; G06F 21/85; G06F 9/30; G06F 11/22

(52) U.S. Cl. CPC G06F 21/54; G06F 21/85; G06F 11/2289; G06F 9/30101; G06F 9/3012

(57) ABSTRACT

A triplication register device includes a first register, a second register and a third register, the three registers being identical and containing the same information in common use, a majority vote device and a self-correction device, the correction being dependent on the result from the majority vote device, each register being controlled by an output of a dual-input multiplexer (mux), the first input corresponding to a functional write operation, the second input corresponding to the result of the majority vote, wherein the triplication device comprises a test device whose function is to block, on command and independently, either the functional write operation to the first register, or the functional write operation to the second register, or the functional write operation to the third register, or the self-correction. The test device may comprise a control register that may also be secured by triplication.

### CROSS-REFERENCE TO RELATED APPLICATIONS

This application claims priority to foreign French patent application No. FR 1914564, filed on Dec. 17, 2019, the disclosure of which is incorporated by reference in its entirety.

### FIELD OF THE INVENTION

The invention is situated in the field of protecting and securing electronic registers on board aircraft intended to travel at air navigation altitudes.

At high altitude, electronic components are exposed to high-energy particles. These particles are typically neutrons. These particles may affect the operation of electronic circuits. By way of example, these particles may change the state of a flip-flop or of a register.

In the aeronautical field, the correct operation of electronic equipment is essential for ensuring the safety of the aircraft, its crew and its passengers. Now, the trend in electronic technologies, which is tending towards greater miniaturization of electronic components, is making these increasingly sensitive to this type of interference.

To overcome this significant drawback, some technical solutions have been implemented in order to protect the most critical components. For example, the most critical registers of programmable logic circuits, known by the acronym PLD for “programmable logic device”, are protected by mechanisms that make them robust to alterations caused by these particles.

Conventionally, it is considered that one and the same particle is able to alter only a single flip-flop of a PLD, unlike “RAM” memories, where a single particle may possibly alter several bits.

Based on this scenario, triplication is a very widespread method for protecting a register. It is described in FIGS. 1 and 2. FIG. 1 shows the majority vote principle, and FIG. 2 shows the complete operation of the registers.

Its principle is as follows. One and the same item of information is stored in three different registers, which are denoted REG. 1, REG. 2 and REG. 3 in FIGS. 1 and 2. These registers are accessible only in write mode.

A “majority vote” equation makes it possible to recover the correct item of information if one and only one of the three registers is altered, this being the most likely case. The probability of two registers being altered at the same time is very low, even with regard to aeronautical standards. Thus, if the two first registers have the same value and the third register has a different value, the majority vote automatically selects the value shared by the two first registers.

A self-correction loop periodically and automatically updates the three registers with the result of the majority vote in order to avoid the alterations building up over time. The frequency of this loop is imposed by a clock, not shown in the figures. If a flip-flop is altered at a given time, the result of the majority vote remains unchanged, and therefore correct, and at the following clock edge the altered flip-flop is corrected. This loop corresponds to the arrow BAC in FIGS. 1 and 2.

Triplication operates bit by bit. If for example the register contains 16 bits, the device has 16 independent triplication mechanisms, as described by FIGS. 1 and 2.

The registers REG. 1, REG. 2 and REG. 3 contain one or more bits. All of the bits are processed individually, independently and in the same way.

The major benefit of triplication is that this principle guarantees that there is never incorrect data at the output of the register, even temporarily.

The self-correction mechanism shares the path which makes it possible to write the functional value VF of the register, as may be seen in FIG. 2. An internal signal makes it possible to choose between this functional write operation and the self-correction.

Generally speaking, the functional write operation is a sporadic event, and the rest of the time it is the self-correction that writes to the registers.

When a functional write operation takes place, the item of functional data is written simultaneously to the three registers. The rest of the time, the output of the majority vote is written continuously, at each clock edge, simultaneously to the three registers by the self-correction loop.

In FIG. 2, all three of the multiplexers are always in the same state, that is to say the three of them are configured so as to perform the functional write operation or to take the self-correction into consideration.

This type of device may be installed in an FPGA component, for “field-programmable gate array”. The design of this system, in order to simplify the implementation in an FPGA for example, is based on the fact that the registers REG 1, REG 2 and REG 3 are accessible only in write mode. Only the corrected value, after the majority vote, is accessible in read mode. Accessing each register in read mode would drastically increase their complexity.

This system is therefore already secure. The aim of the invention is to further bolster security by providing this system with test capabilities able to monitor the correct operation of the write operation to the registers, of the majority vote system and of the self-correction without needing to read each register.

### BACKGROUND

One subject of the invention is therefore a triplication register device comprising a first register, a second register and a third register, the three registers being identical and containing the same information in common use, a majority vote device and a self-correction device, the correction being dependent on the result from the majority vote device, each register being controlled by the output of a dual-input multiplexer, the first input corresponding to a functional write operation, the second input corresponding to the result of the majority vote, characterized in that the triplication device comprises a test device whose function is to block, on command and independently, either the functional write operation to the first register, or the functional write operation to the second register, or the functional write operation to the third register, or the self-correction.

Advantageously, the test device comprises a control register containing at least four control bits, the first bit controlling the blocking of the functional write operation to the first register, the second bit controlling the blocking of the functional write operation to the second register, the third bit controlling the blocking of the functional write operation to the third register and the fourth bit controlling the blocking of the self-correction.

Advantageously, each control bit of the control register blocks all of the bits of the register associated with said control bit.

Advantageously, a first test configuration consists in blocking only the self-correction so as to check that the three registers are operating in a nominal manner.

Advantageously, a second test configuration consists in blocking only the write operation to the first register and the second register or the write operation to the first register and the third register or the write operation to the second register and the third register so as to check that the majority vote device is operating in a nominal manner.

Advantageously, a test comprises a sequence of first, second or third configurations taken in this order or in a different order.

Advantageously, the control register contains sixteen bits and the test device comprises a set of four secondary majority vote devices:

the twelve first bits being organized into three groups of four identical control bits, each secondary majority vote device being driven by three control bits belonging respectively to the first group, to the second group and to the third group, each bit blocking the same function, either functional write operation or self-correction, the result of the majority vote blocking said function,

the last four bits being used to reread the four results from the four secondary majority vote devices.

The invention also relates to an electronic system on board an aircraft subject to high-altitude flying conditions, comprising at least one triplication register device as described above.

### BRIEF DESCRIPTION OF THE DRAWINGS

Other features, details and advantages of the invention will become apparent upon reading the description provided with reference to the appended drawings, which are given by way of example and in which, respectively:

FIG. 1 shows an illustration of the principle of a majority vote triplication register according to the prior art;

FIG. 2 shows an illustration of the principle of a majority vote triplication register according to the prior art, comprising multiplexing with functional writing to the registers;

FIG. 3 shows an illustration of the principle of a majority vote triplication register according to the invention;

FIG. 4 shows an illustration of the configuration in functional mode of the triplication register according to the invention;

FIG. 5 shows an illustration of a first test configuration of the triplication register according to the invention;

FIG. 6 shows an illustration of a second test configuration of the triplication register according to the invention;

FIG. 7 shows an illustration of a third test configuration of the triplication register according to the invention;

FIG. 8 shows an illustration of a control register of the test device according to the invention comprising a set of four secondary majority vote devices.

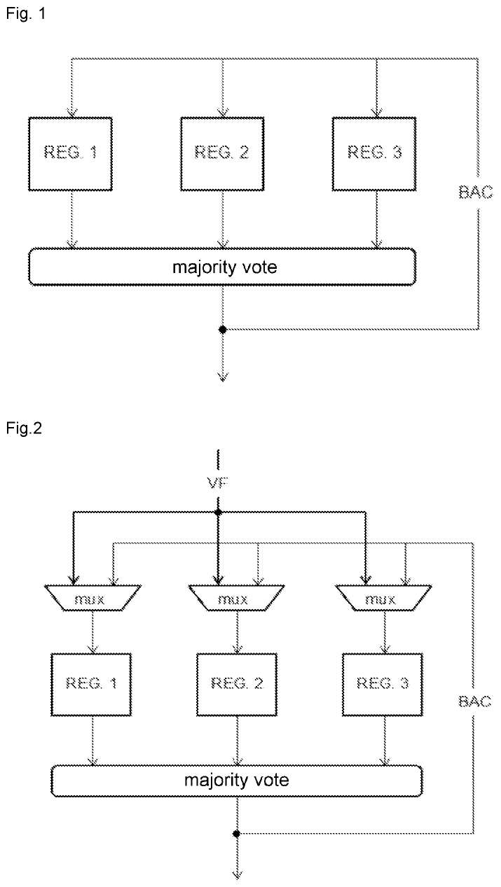

### DETAILED DESCRIPTION

The aim of the invention, with regard to the current operation of a triplication register, is to be able to check the correct operation of all of the elements of the majority vote triplication mechanism so as to detect that no latent fault renders the triplication inoperative. The faults detected by the test device according to the invention are as follows:
one of the three registers is stuck at a constant value or is unable to perform a functional write operation when required;
the self-correction is not working;
the majority vote is incorrect for one or more combinations of the values of the three registers.

In aeronautics, electronic equipment has to meet stringent safety and reliability requirements. These requirements are governed by a standard called RTCA DO-254/Eurocae ED-80 entitled “Design Assurance Guidance for Airborne Electronic Hardware”. This standard defines five criticality levels, what are called “DAL” levels, acronym for “Design Assurance Level”. The most severe is level A, which defines system faults liable to cause a catastrophic problem: compromised flight safety or landing or the aircraft crashing. The device according to the invention is compatible with DAL level A.

The principle of the invention is based on two separate elements:

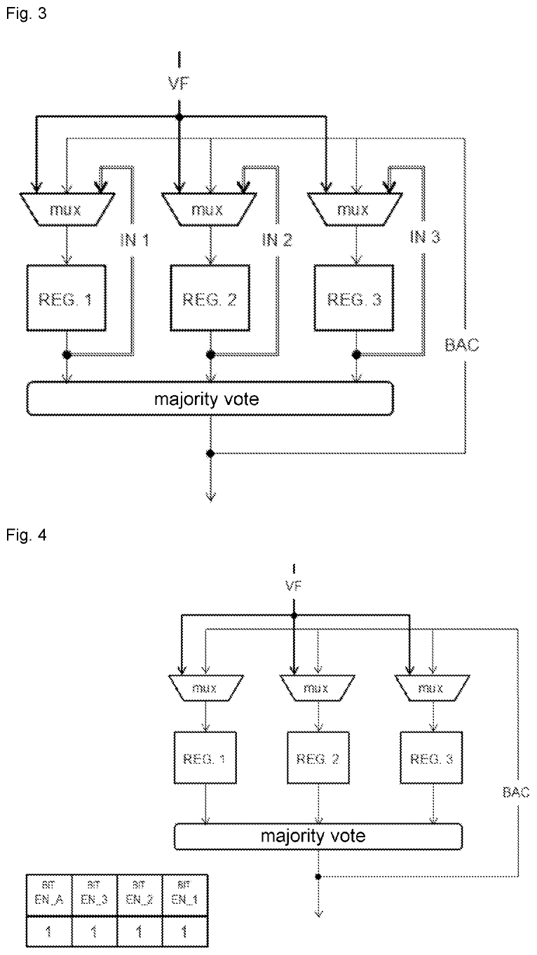

The possibility of individually blocking the write operations to each register during the functional write operation in order to be able to intentionally inject a different value into each register and to check the operation of the majority vote and the self-correction mechanism. This blocking process is shown in FIG. 3, which shows a majority vote triplication register comprising three registers REG. 1, REG. 2 and REG. 3. It is represented by three double arrows IN 1, IN 2 and IN 3, each arrow blocking one of the three registers. This depiction is purely symbolic.

The possibility of blocking the self-correction, thereby leaving the possibility of observing the result of the majority vote with different values in the three registers.

One simple means for creating the test device is to implement a dedicated control or test register whose function is to position the internal signals that will activate the test modes for the triplication. This control register for the test may conventionally be driven by the software of the system that controls the triplicate register. It may also however be driven by a hardware machine responsible for performing the built-in equipment test, known by the acronym “BITE” for “built-in test equipment”.

In its basic version, the test register contains 4 control bits: three bits denoted EN_1, EN_2, EN_3 and one bit denoted EN_AUTOCORRECT, the effects of which are as follows:

If the bit EN_1 is at 1, then the functional write operation writes to the register REG 1. This is tantamount to retaining normal operation of the register.

If the bit EN_1 is at 0, then the functional write operation does not write to REG 1, that is to say that the register remains unchanged. The register is in test mode.

The bits EN_2 and EN_3 have the same operation with regard to the two registers REG 2 and REG 3 respectively.

If the bit EN_AUTOCORRECT is at 1, then the self-correction takes place normally on the three registers.

If the bit EN_AUTOCORRECT is at 0, then the self-correction is blocked on the three registers, that is to say that only the functional write operation is able to modify the three registers.

It should be noted that the choice of “1” or “0” to block or not block the functions is purely arbitrary.

The four bits and their action are completely independent. Each bit of the control register acts collectively on all of the bits of the registers REG 1, REG 2 and REG 3. For example, if REG 1, REG 2 and REG 3 are 16-bit registers, there is just a single bit EN_1 in the control register, and it acts collectively and in the same way on the 16 bits of REG 1.

To gain a good understanding of the action of the control register, FIGS. 4, 5, 6 and 7 show various configurations in functional mode and in test mode of the triplicate register, with the indication of the value of the four bits of the control register in a table.

In the normal operating configuration shown in FIG. 4, the four bits of the test register are at 1. The functional write operation takes place normally to the three registers, and besides the functional write operations, the self-correction continuously writes to the three registers.

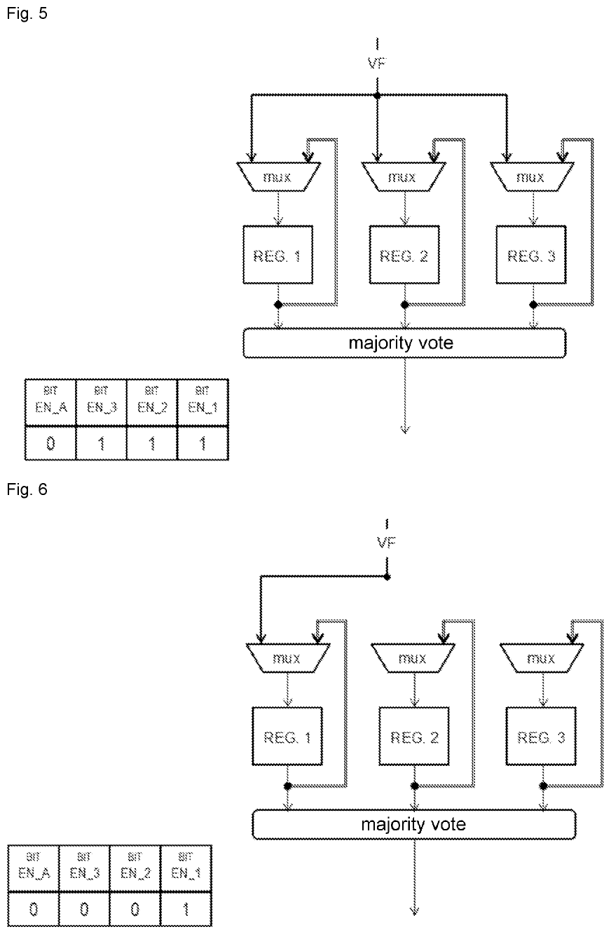

In the first test configuration shown in FIG. 5, the bit EN_AUTOCORRECT is at 0, and the other three bits are at 1. The functional write operation takes place normally to the three registers, but besides the functional write operations, the registers remain unchanged because the self-correction is blocked. This case makes it possible to check that the result of the vote is consistent with the functional write operation chain.

In the second test configuration shown in FIG. 6, the bit EN_1 is at 1, and the other three bits are at 0. The functional write operation takes place normally but only to the register REG 1, and besides the functional write operations, the register REG 1 remains unchanged. The registers REG 2 and REG 3 are no longer addressed and still remain unchanged. This case makes it possible to check the correct operation of the majority vote through the modification of the value of a single register.

By alternating the values of the bits of EN_1, EN_2 and EN_3, each register is written to individually and the majority vote is tested with all of its input combinations. It is checked at the same time that the write operation to each of the registers takes place correctly, that is to say that none of the three registers are stuck at a constant value.

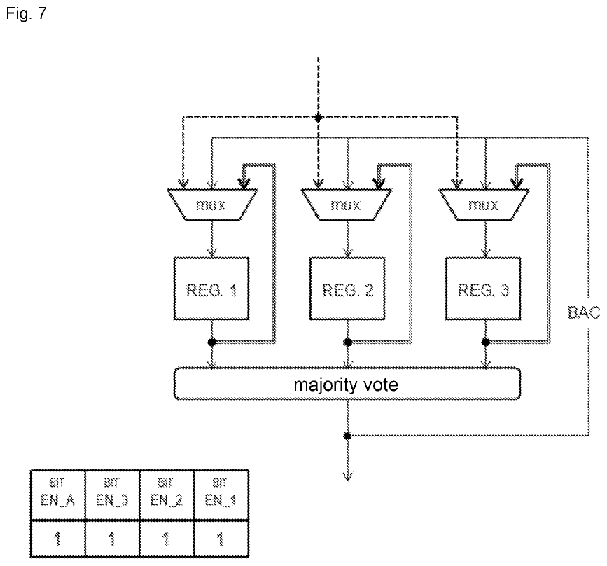

In the third test configuration shown in FIG. 7, the four bits of the test register are at 1. The functional write operation is normally possible, but it is not used. The three registers are written to continuously by the self-correction. This case makes it possible to check the correct operation of the self-correction when it is applied after having written different values to the three registers.

It is of course possible to combine the above configurations. As a first example, if, after having used three second configurations to place different values in the three registers, the third configuration is positioned, then the three registers become identical, given the majority vote which necessarily leads to identical values.

A second more complex example of combinations makes it possible to perform more sophisticated tests. For clarity, this example is broken down into two successive steps.

In a first step, using the first configuration three times to write the combination “0, 0, 1” to the registers REG 1, REG 2 and REG 3, rereading the majority vote gives 0. 1 is then written to REG 2, thereby giving the combination “0, 1, 1”, and rereading the majority vote then gives 1.

In a second step, using the first configuration three times to write the combination “0, 0, 1” to the registers REG 1, REG 2 and REG 3, rereading the majority vote gives 0. The second configuration is then used. If the self-correction is operating correctly, there is a change to the combination “0, 0, 0”. The first configuration is used again. 1 is written to REG 2, thereby this time giving the combination “0, 1, 0”, and rereading the majority vote this time gives 0.

Thus, at the end of the second step, the result of the majority vote is different from what it is at the end of the first step. It is thus checked that the self-correction worked in the register REG 3 for the change from 1 to 0.

By repeating the second step with various possible combinations, it is checked that the self-correction works for the three registers with the two transitions from 1 to 0 and 0 to 1.

As has just been seen, the blocking test device according to the invention makes it possible to easily check that all of the write operations, majority vote operations and self-correction operations are working correctly. However, it is possible to further increase the security of the triplication register by securing the control and test register.

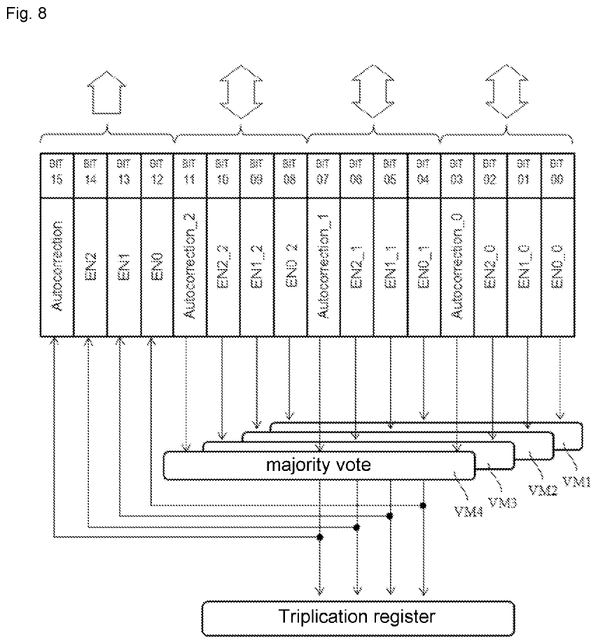

Triplication is also used for this purpose, but this time applied to the control register itself. This secure control register is shown in FIG. 8. It contains 16 bits numbered from 0 to 15 and distributed as follows.

The four control bits EN_1, EN_2, EN_3, and EN_AUTOCORRECT are triplicated, thereby making a total of 12 bits. They correspond to the bits numbered 0 to 11 in FIG. 8. The three instances of the four bits are written individually to the control register. In contrast to the tested registers REG 1, REG 2 and REG 3, for test purposes, this control register is accessible in read and write mode to the software of the system that controls the triplicate register or to dedicated software. In FIG. 8, the read/write operation on the bits is symbolized by a double-headed arrow, and the simple read operation on the bits is symbolized by a one-way arrow.

The test device comprises a set of four secondary majority vote devices denoted VM1, VM2, VM3 and VM4 in FIG. 8. Each secondary majority vote device is driven by three control bits that are replicated, that is to say supposed to contain the same control information.

The results of the four majority votes control the triplication register and are also stored in the control register. Four additional bits are therefore necessary. These are the bits numbered from 12 to 15 in FIG. 8. These bits are accessible only in read mode. In total, 16 bits are therefore necessary to achieve triplication of the control register.

By the same token, a single control register may be associated with several triplicate functional registers, without limiting the number of registers to be controlled.

The triplicate control register does not have a self-correction function, thereby making the test thereof much easier. The absence of self-correction of the self-correction register does not have any significant effect for the two reasons described below.

The first reason is that it is necessary to have two well-placed alterations for a control operation to be altered, this being an exceptionally rare event.

The second reason is that altering a control bit does not have any immediate impact, and it is then necessary for the functional register itself also to be altered after the control register for there to be any functional impact. In this case too, these are only very exceptional events.

If the self-correction control bit is altered, it is then necessary for two well-placed bits in the functional register to be altered after the control register is altered. This may for example involve two of the three triplication registers associated with the same functional bit.

If an “EN” functional control bit is altered, the functional write operation is impaired because one incorrect bit out of the three is potentially written, but the majority vote still gives the correct value, and it is necessary for a bit of the functional register also to be altered for there to be an impact. This situation has an impact only if the events occur in the following order: double alteration of the control operation and then functional write operation with a value different from the previous value on the bit in question, and then double alteration on the triplicate registers of this bit. This situation is highly unlikely.

Therefore, the absence of self-correction on the control register does not lead to any significant risk.

A first example of chains of events that would be likely to cause a significant alteration of the register is described below:

First event: the bit EN0_0 is altered. There is no impact by virtue of the majority vote.

Second event: one of the two bits EN0_1 or EN0_2 is also altered. The register REG 1 will not be updated in the next write operation. However, the current value of REG 1 is not modified, and there is therefore no functional impact. Next, in the next functional write operation, the register REG 1 is not written to, and it is therefore potentially different from REG 2 and REG 3. However, there is still no functional impact by virtue of the majority vote. In the following clock cycle, the self-correction will update the register REG 1 with the correct value. The correct written value appears in REG 1, simply with a delay clock period.

Third event: One of the registers REG 2 or REG 3 is altered exactly during the clock period that follows the functional write operation. There is then a functional impact.

It is understood that the cascade of the three events is highly unlikely and may be neglected. The absence of self-correction on the EN bits therefore does not constitute a risk.

A second example of chains of events that would be likely to cause a significant alteration of the register is described below:

First event: the bit AUTOCORRECT_0 is altered. There is no impact by virtue of the majority vote.

Second event: one of the two bits AUTOCORRECT_1 or AUTOCORRECT_2 is altered. The self-correction of the registers REG 1, REG 2 and REG 3 is blocked, but the current value of the registers is not modified. There is no functional impact.

Third event: one of the three registers REG1, REG 2 or REG 3 is altered. There is still no functional impact by virtue of the majority vote.

Fourth event: Another of the three registers REG1, REG 2 or REG 3 is in turn altered. A functional impact occurs.

It is therefore seen that, even if two bits out of the three bits AUTOCORRECT 0, AUTOCORRECT 1 or AUTOCORRECT 2 are altered, the probability of there being a functional consequence is extremely low and requires the occurrence of four successive events, themselves having a low probability.

The absence of self-correction on the AUTOCORRECT bits therefore does not constitute a risk.

To test that the triplication of the control bits and their majority vote is working correctly, it is enough simply to write all of the combinations of the twelve control bits and each time to reread the four bits of the majority vote. This procedure covers both the majority vote and the control bits themselves. This test makes it possible to detect that one of the bits is fixed at 0 or 1 due to an electronics fault.

The triplication register device according to the invention has a security level sufficient for a DAL A-certified avionic system. It has the following advantages.

The device makes it possible to test 100% of the fault or error correction mechanism. The test coverage of the correction mechanism is fully exhaustive.

A simple fault with or a simple alteration of the test device does not cause erroneous functional data. Such a simple fault with the test device may be detected before a multiple fault occurs.

The test device does not have any impact on the operational performance of the tested register.

The test device associated with each functional register is very easy to implement, and therefore does not impair reliability and consumes few resources of the electronic component carrying it.

The control register according to the invention may be pooled with as many functional registers as desired, thereby minimizing the number of control registers.

1. A triplication register device comprising a first register (REG. 1), a second register (REG. 2) and a third register (REG. 3), the three registers being identical and containing the same information in common use, a majority vote device and a self-correction device (BAC), the correction being dependent on the result from the majority vote device, each register being controlled by the output of a dual-input multiplexer (mux), the first input corresponding to a functional write operation, the second input corresponding to the result of the majority vote, wherein the triplication device comprises a test device whose function is to block, on command and independently, either the functional write operation to the first register, or the functional write operation to the second register, or the functional write operation to the third register, or the self-correction.

2. The triplication register device according to claim 1, wherein the test device comprises a control register containing at least four control bits (EN_1, EN_2, EN_3, EN_A), the first bit controlling the blocking of the functional write operation to the first register, the second bit controlling the blocking of the functional write operation to the second register, the third bit controlling the blocking of the functional write operation to the third register and the fourth bit controlling the blocking of the self-correction.

3. The triplication register device according to claim 2, wherein each control bit of the control register blocks all of the bits of the register associated with said control bit.

4. The triplication register device according to claim 3, wherein a first test configuration consists in blocking only the self-correction so as to check that the three registers are operating in a nominal manner.

5. The triplication register device according to claim 3, wherein a second test configuration consists in blocking only the write operation to the first register and the second register or the write operation to the first register and the third register or the write operation to the second register and the third register so as to check that the majority vote device is operating in a nominal manner.

6. The triplication register device according to claim 2, wherein a test comprises a sequence of first, second or third configurations taken in this order or in a different order.

7. The triplication register device according to claim 1, wherein the control register contains sixteen bits and that the test device comprises a set of four secondary majority vote devices (VM1, VM2, VM3, VM4),
the twelve first bits being organized into three groups of four identical control bits, each secondary majority vote device being driven by three control bits belonging respectively to the first group, to the second group and to the third group, each bit blocking the same function, either functional write operation or self-correction, the result of the majority vote blocking said function,
the last four bits being used to reread the four results from the four secondary majority vote devices.

8. An electronic system on board an aircraft subject to high-altitude flying conditions, comprising at least one triplication register device, wherein said triplication device is in accordance with claim 1.
